(19) United States
(12) Patent Application Publication
(10) Pub. No.: US 2026/0333542 A1
(43) Pub. Date: Oct. 22, 2026

(54) SEMICONDUCTOR LIGHT SOURCE AND MEASURING METHOD

(71) Applicant: AMS-OSRAM International GMBH, Regensburg (DE)

(72) Inventors: Patrick HÖRNER, Bamberg (DE); Daniel KRAUS, Regensburg (DE); Michael JOBST, Wiesenfelden (DE); Erwin LANG, Regensburg (DE); Martin HUTZL, Regensburg (DE); Igor STANKE, Regensburg (DE); Stefan GRÖTSCH, Bad Abbach (DE)

(21) Appl. No.: 19/481,889

(22) PCT Filed: Jul. 10, 2024
(86) PCT No.: PCT/EP2024/069522

§ 371 Date: Nov. 6, 2025

(30) Foreign Application Priority Data
Jul. 26, 2023 (DE) 10 2023 119 778.9

(51) Int. Cl. H05B 45/52; H05B 45/54; H05B 45/58

(52) U.S. Cl. CPC H05B 45/52; H05B 45/54; H05B 45/58

(57) ABSTRACT

A semiconductor light source including a plurality of lighting strips and a control unit, wherein each of the lighting strips includes a plurality of optoelectronic semiconductor chips for generating light, such as μLEDs, the lighting strips are operated in the same way, and the control unit includes a comparison module which is configured to detect at least one electric parameter of each of the lighting strips and to use numerical values for the individual lighting strips of the detected at least one electric parameter for a fault analysis.

### CROSS-REFERENCE TO RELATED APPLICATIONS

This application is a national phase of International Application No. PCT/EP2024/069522 filed on Jul. 10, 2024, which claims priority to German Patent Application No. 10 2023 119 778.9, which was filed on Jul. 26, 2023, the entire contents of both of which are incorporated herein by reference.

### FIELD OF THE INVENTION

A semiconductor light source is provided. In addition, a measurement method for such a semiconductor light source is provided.

### BACKGROUND OF THE INVENTION

Documents U.S. Pat. No. 7,878,103 B1 and US 2014/0 152 180 A1 relate to LED circuits.

### SUMMARY OF THE INVENTION

An object to be solved is to specify a semiconductor light source in which defects can be reliably detected.

This object is achieved, inter alia, by a semiconductor light source and by a measurement method with the features of the independent patent claims. Preferred embodiments are the subject of the dependent claims.

According to at least one embodiment, the semiconductor light source comprises a plurality of lighting strips. Each of the lighting strips comprises one or more optoelectronic semiconductor chips. The semiconductor chips are configured to generate radiation, in particular to generate visible light. The visible light can be generated directly in a semiconductor layer sequence of the optoelectronic semiconductor chip concerned or at least one phosphor is associated with the optoelectronic semiconductor chip concerned, which converts at least part of the radiation emitted directly by the optoelectronic semiconductor chip concerned into radiation of a different wavelength.

The semiconductor layer sequences of the optoelectronic semiconductor chips each have at least one active zone which, in operation, is configured to generate radiation by means of electroluminescence. The radiation generated is incoherent in the case of a light-emitting diode chip, or LED chip for short, or in particular coherent in the case of a laser diode chip, or LD chip for short. The semiconductor layer sequences are preferably based on a III-V compound semiconductor material. For example, the semiconductor material is a nitride compound semiconductor material such as AlₙIn₁₋ₙ₋ₘGaₘN or a phosphide compound semiconductor material such AlₙIn₁₋ₙ₋ₘGaₘP or an arsenide compound semiconductor material such as AlₙIn₁₋ₙ₋ₘGaₘAs or AlₙGaₘIn₁₋ₙ₋ₘAsₖP₁₋ₖ, where in each case 0≤n≤1, 0≤m≤1 and n+m≤1 as well as 0≤k<1. For example, 0<n≤0.8, 0.4≤m<1 and n+m≤0.95 and 0<k≤0.5 apply for at least one layer or for all layers of the semiconductor layer sequence. The semiconductor layer sequences can have dopants and additional components. For the sake of simplicity, however, only the essential components of the crystal lattice of the semiconductor layer sequence, that is, Al, As, Ga, In, N or P, are specified, even if these may be partially replaced and/or supplemented by small amounts of other substances.

Several types of optoelectronic semiconductor chips can be combined in the lighting strips. The term ‘types’ refers, for example, to different emission colors. It is possible that the optoelectronic semiconductor chips are the only light source of the semiconductor light source.

According to at least one embodiment, the semiconductor light source comprises one or more control units, also referred to as driver ICs. The at least one control unit is configured to electrically control and operate the optoelectronic semiconductor chips, in particular the optoelectronic semiconductor chips combined to form the lighting strips. For example, the at least one control unit determines which current is applied to the individual lighting strips and optoelectronic semiconductor chips and for how long. For example, the at least one control unit has one or more current outputs to which the at least one associated lighting strip is connected.

According to at least one embodiment, the lighting strips are operated in the same way. For example, the optoelectronic semiconductor chips of the relevant lighting strips are subject to the same ambient conditions, such as temperature and humidity, and/or are operated synchronously with each other, for example with the same current levels.

According to at least one embodiment, the at least one control unit comprises at least one comparison module. The at least one comparison module is configured to detect at least one electric parameter from each of the lighting strips. For example, the electric parameter is a forward voltage. A numerical value of the electric parameter is determined for each of the lighting strips. For example, the forward voltage is recorded for each of the lighting strips.

According to at least one embodiment, the at least one comparison module is configured to use the numerical values of the recorded at least one electric parameter for the individual lighting strips for a fault analysis. This means, for example, that the numerical values, such as the individual forward voltages of the lighting strips, are compared with each other. If a comparison provides too large a deviation from a setpoint value, such as a threshold value, or a setpoint value range, such as a value range between two threshold values, a fault is detected by the at least one comparison module. The fault is, for example, a defect or a failure of at least one optoelectronic semiconductor chip of the at least one lighting strip in question.

It is possible that the at least one comparison module is s configured to output an error message if the fault analysis reveals an error. The error message is sent, for example, to a control unit of a device, such as a motor vehicle, in which the semiconductor light source is installed.

In at least one embodiment, the semiconductor light source comprises a plurality of lighting strips and a control unit, wherein
each of the lighting strips comprises one or more optoelectronic semiconductor chips for generating light,
the lighting strips are operated in the same way, and
the control unit comprises a comparison module which is configured to detect at least one electric parameter of each of the lighting strips and to use numerical values for the individual lighting strips of the detected at least one electric parameter for a fault analysis.

For example, fault detection of individual LEDs in LED segments or in the lighting strips is based on a voltage measurement. This means, for example, that individual LED faults can be detected in larger LED segments. A fault is, for example, an interrupted electrical line section or an electrical short circuit, also known as an open or short. Fault detection can be independent of environmental influences, such as temperature, or ageing of the optoelectronic semiconductor chips.

In some LED applications, particularly in the automotive industry, failures of individual LEDs in a luminaire are undesirable as such failures could impair safety or have a detrimental effect on the design. Fault detection of individual short-circuited or open LEDs is therefore necessary.

In larger luminaires with a high LED density, a series or parallel connection of LEDs is common, so that electronic monitoring of a single LED is generally no longer possible. If there are several LEDs in a series and/or parallel circuit, fault detection of a short circuit/interruption becomes increasingly difficult with increasing string length/number of parallel strings.

Short circuits or open connections in LED circuits can be detected by measuring the forward voltage and comparing the value with a corresponding reference. When LEDs are connected in series and/or parallel, the variations in the forward voltages, which may be due to binning, temperature and/or ageing of the individual LEDs, for example, add up in the worst case to such an extent that the cumulative variation exceeds the signal to be measured, that is, a voltage change due to a short circuit or open contact of an LED. Binning is understood in particular as an assignment of LEDs to a certain class, whereby within the class all LEDs have the same properties, for example, the same emission color or the same forward voltage, within specified tolerances.

With the semiconductor light source described herein, this problem is solved, for example, by comparing the forward voltages of several similar series circuits and/or parallel circuits with each other. The use of a reference allows disturbances with the same direction, such as temperature and, under certain circumstances, ageing, to be averaged out during measurement, thus increasing the sensitivity of fault detection.

The lighting strips and the LED segments are operated in particular with the help of a driver IC, whose driver channels can be configured as current sources or sinks. The number of LEDs in the circuit, that is, per lighting strip, is for example 1, 5 or 10. The interfering influences should be minimized by a local adjacent arrangement of two or more LED segments or lighting strips, which are operated in particular in the same manner, and the measurement evaluation in the driver IC in order to enable fault detection in larger series circuits and/or parallel circuits. For example, the difference between the forward voltages of two adjacent lighting strips within a segment is determined and compared with a corresponding limit value. If the difference between the forward voltages exceeds the limit value, a fault is registered. Monitoring of the lighting strips and LED segments and fault detection is integrated into the driver IC, for example. IC stands for integrated circuit.

This means that several locally adjacent lighting strips within a segment can be used as a reference to each other. The driver IC is used to assign the lighting strips and/or segments that serve as a reference to each other. By using a driver IC with ADC measurements on the driver channels, individual initial values and error limit values can be stored for the individual lighting strips and/or segments. A single ADC in the IC can be used for the voltage measurement, such as a differential measurement, so that individual channels to be compared are switched through to the same ADC, corresponding to multiplexing. This eliminates the error deviation on the absolute measured value of the ADC and thus the detection accuracy is increased.

For example, the following aspects are realized in the semiconductor light source described herein, individually or in any combination with each other:
There is an operation of a comparative system of two or more individual LED lighting strips within an LED segment, which are exposed to very similar environmental conditions and, for example, are locally close to each other.
Several such systems can be installed on one LED module so that the semiconductor light source can be composed of several groups of lighting strips.
An individual/flexible grouping of the driver channels to be compared is possible.
It is possible to determine the voltage differences from the individually measured voltage values of the lighting strips within a system.
It is possible to operate the lighting strips and/or LED segments to be compared within a system using constant current sources or constant current sinks with ideally the same current.
Different temperatures of the lighting strips and/or segments to be compared can be avoided.
Equal operating conditions of the lighting strips and/or segments to be compared with each other, in particular equal ageing, can be guaranteed.
Individually defined initial values/reference values for the voltage at a defined current in a lighting strip and/or segment can be stored in a non-volatile memory.
Measured values from the production line can be used as initial values, for example, an initial value, also known as a 0 h value.
Newly read reference values can be taken into account.
A limit value for the deviating voltage at a defined current that is adapted to the system, in particular to two lighting strips and/or segments that are close to each other, can be stored in a non-volatile memory.
Depending on the properties of the LEDs used, such as color, semiconductor material system, segment size, binning and/or aging, the limit values can be stored individually.
It is possible to store error tolerances, for example, 6-sigma ranges.
Repetitive measurements, for example, at 10 ms intervals, of the voltages dropping across the lighting strips and/or segments to be compared at a defined current can be performed directly on the driver channel using an ADC.
When using pulse width modulation, PWM for short, measurements can be taken during an on-time.
It is possible to evaluate the differential voltage of the system at a defined current.
If the differential value between the lighting strips and/or segments to be compared exceeds the set limit value, an error can be registered.
Individual control of the driver channels is possible.
Lighting strips and/or segments can be switched off in the event of a fault, as an alternative or in addition to feedback to a higher-level control unit.

For example, the semiconductor light source described herein can be used to achieve the following effects, individually or in any combination:
Due to similar environmental conditions, voltage-changing influences, for example temperature, humidity and/or corrosion, affect both lighting strips and/or LED segments to be compared equally.
The disturbances affect the lighting strips and/or segments to be compared equally and are eliminated in the comparative measurement and larger lighting strips and/or segments can be tested for faults.
By grouping the channels, a bus load in the control of the IC can be reduced. For example, only one control signal runs via the bus for all lighting strips to be compared with each other.
If the voltage differences are measured directly, for example, using a subtractor, the measurement can have a very high resolution for a small voltage range. For example, 8 bits to 3 V are possible. This allows a higher measurement accuracy to be achieved.
Flexible, individual operation of the lighting strips and/or LED segments to be compared is possible if no fault detection is required.
Temporary individual energization of the lighting strips can be carried out.
Driver ICs with double individual outputs can be used so that the lighting strips can be permanently energized individually.
Fault detection does not necessarily have to be used or is only used temporarily.
No separate measuring line or component on the LED module is required for fault detection.
Large symbols to be displayed in a device with the semiconductor light source or lighting patterns with large lighting strips and/or LED segments can be divided between several driver channels.
Greater design freedom is possible.
Individually defined initial voltages/reference values stored in a non-volatile memory, NVM for short, offer flexible adaptation to different LED systems that can be installed in the semiconductor light source.
Individual initialization can be programmed without changing the hardware.
A reset to a new initial value can be programmed.
Individually stored limit values in a non-volatile memory offer flexible adaptation to different LED systems in the semiconductor light source.
An initial comparison measurement can be carried out with 100% functioning lighting strips and/or optoelectronic semiconductor chips in order to enable an initial calibration on the measuring lines so that any initial voltage differences no longer have any effect on the fault analysis.
A higher reliability in fault detection can be achieved.

According to at least one embodiment, some or all of the optoelectronic semiconductor chips are electrically connected in series within some or all of the lighting strips. This means that pure series circuits or mixtures of series circuits and parallel circuits may be present. For example, the number of parallel circuits is at most 50% or is at most 30% or is at most 15% of a number of optoelectronic semiconductor chips of the corresponding lighting strip.

According to at least one embodiment, some or all of the lighting strips are mounted on a common carrier. The common carrier is, for example, a circuit board, such as a printed circuit board or a metal core board, or a foil.

According to at least one embodiment, some or all of the lighting strips are configured to be operated simultaneously. This means that when one lighting strip is operated, all other associated lighting strips are also operated. In other words, the lighting strips assigned to each other have the same or approximately the same operating times. Only lighting strips that are assigned to one reference unit need to be operated simultaneously. Other lighting strips can be operated independently.

According to at least one embodiment, the operating times of the lighting strips assigned to each other differ from each other by a factor of at most 1.2 or by a factor of at most 1.1 or by a factor of at most 1.05. This applies alternatively or additionally to the optoelectronic semiconductor chips of the respective lighting strips.

According to at least one embodiment, the temperatures of the lighting strips assigned to one another deviate from one another by a maximum of 10° C. or by a maximum of 5° C. or by a maximum of 2° C. This means, for example, that all optoelectronic semiconductor chips of the respective lighting strips have the same or approximately the same temperature during operation of the semiconductor light source.

According to at least one embodiment, the relative ambient humidity of the lighting strips assigned to one another differs from one another by no more than ten percentage points or by no more than five percentage points or by no more than two percentage points. This means, for example, that all optoelectronic semiconductor chips of the lighting strips in question are operated at the same or approximately the same humidity.

Thus, the lighting strips assigned to each other are in particular configured to be operated in the same way so that the operating temperature, the operating humidity and/or the operating time or ageing are the same or approximately the same.

According to at least one embodiment, the associated lighting strips are close to each other. This means, for example, that a distance between neighboring lighting strips is at most 1 cm or at most 4 mm or at most 2 mm. These distances can also apply to neighboring optoelectronic semiconductor chips within the lighting strips. The distance between the neighboring lighting strips is, for example, a distance between carriers of the lighting strips in question and/or a distance between optoelectronic semiconductor chips of the lighting strips in question.

According to at least one embodiment, the at least one comparison module is configured to determine differences from the numerical values for the lighting strips and to compare them with at least one threshold value that is stored in the comparison module. The threshold value can also be referred to as a limit value. For example, it is assumed that a fault is present if the differences in, for example, the forward voltages of the lighting strips concerned are below and/or above certain threshold values.

According to at least one embodiment, some or all of the lighting strips have the same structure. Identically constructed means, for example, that these lighting strips have the same number and/or the same composition of optoelectronic semiconductor chips. For example, these lighting strips each have a certain number A of LED chips for a first color and a certain number B of LED chips for a second color and optionally a certain number C of LED chips for a third color and optionally a certain number D of LED chips for a fourth color. Equally constructed can also mean that the same additional active electrical components are present, such as sensors or diodes for protection against electrostatic discharges.

According to at least one embodiment, the same threshold value or the same threshold values apply to the lighting strips with the same structure. With regard to a fault analysis, it is therefore possible for these lighting strips to be treated in the same way.

According to at least one embodiment, some or all of the lighting strips have a different structure. This means, for example, that these lighting strips have different numbers of optoelectronic semiconductor chips and/or different compositions of optoelectronic semiconductor chips, that is, in particular different ensembles of emission colors of the optoelectronic semiconductor chips.

According to at least one embodiment, different threshold values apply to the lighting strips with different compositions. This makes it possible to extend the fault analysis to differently constructed lighting strips.

According to at least one embodiment, the comparison module comprises at least one memory unit, such as an NVM. Optionally, the at least one memory unit is configured to store the at least one threshold value dynamically. Dynamic means that the at least one threshold value can be changed, either by the control unit itself or externally, for example, by means of a cable connection or a wireless data connection.

According to at least one embodiment, the lighting strips are configured to be operated with the same total current intensity different from zero when the electric parameter is detected. This means that the total currents through the relevant lighting strips differ from each other, for example, by a factor of at most 1.1 or by a factor of at most 1.05 or by a factor of at most 1.02. In particular, the electric parameter is the forward voltage of the lighting strips in question.

According to at least one embodiment, the comparison module comprises one or more measurement analog-to-digital converters, measurement ADCs for short. The ADC, which determines the numerical values of the lighting strips of the at least one electric parameter, can thus be an integral part of the control unit, that is, the driver IC.

According to at least one embodiment, all numerical values of the at least one electric parameter are recorded with the same measuring ADC. The numerical values are recorded, for example, by means of time division multiplexing so that the relevant channels are measured one after the other.

According to at least one embodiment, the comparison module is configured to detect a time course of the at least one electric parameter. This means, for example, that the relevant numerical values are recorded several times. The detection can be periodic or aperiodic. For example, a detection frequency is at least once per hour or at least once per minute or at least 1 Hz or at least 10 Hz or at least 50 Hz. Alternatively or additionally, this frequency is at most 1 kHz or at most 0.1 kHz.

According to at least one embodiment, some or all of the lighting strips comprise at least two or at least five or at least eight or at least ten of the optoelectronic semiconductor chips. Alternatively or additionally, said number is at most 200 or is at most 100 or is at most 50.

According to at least one embodiment, the semiconductor light source comprises at least three or at least four or at least six or at least ten of the lighting strips. Alternatively or additionally, said number is at most 300 or at most 100 or at most 50.

According to at least one embodiment, the control unit is configured to compare the numerical values of the lighting strips, which are assigned to said control unit, with each other in a pairwise manner. For example, if the three numerical values V1, V2, V3 are available for the forward voltage, V1 is compared with V2, and V1 with V2, and V2 with V3. In other words, a rolling comparison can be made.

Alternatively, it is possible for the numerical values to be compared with an average of the numerical values.

According to at least one embodiment, the lighting strips are operated with PWM. The measurement of the numerical values, for example, for the forward voltage, is preferably carried out in the on-time during which the at least one lighting strip in question is energized. For example, the measurement starts at the beginning of an energization phase, also known as the duty cycle, and lasts for a maximum of as long as the duty cycle. The measurement of the assigned numerical value is then preferably coupled to the corresponding PWM frequency and synchronized with the PWM control.

According to at least one embodiment, the lighting strips are combined into several groups of at least two lighting strips each. It is possible that the lighting strips within some or all of the groups have the same structure. This enables efficient comparison between the lighting strips within the groups.

The groups can also be referred to as segments. The groups are thus formed from the individual lighting strips, which in turn are then compared with each other. Several lighting strips therefore form a segment, that is, a group.

According to at least one embodiment, each group has its own control unit. Alternatively, all groups are assigned to the control unit or there is at least one control unit to which more than one group is assigned.

According to at least one embodiment, the at least one control unit is configured to perform the fault analysis for each of the groups individually. This means that the fault analysis is performed at group level. Whether a fault is present within a group can thus be determined independently of the other groups.

According to at least one embodiment, some or all of the optoelectronic semiconductor chips are micro-LEDs. For example, a micro-LED is any light-emitting diode, or LED for short, and in particular not a laser, with a particularly small size. It is possible for micro-LEDs to have a growth substrate removed, so that the height of such micro-LEDs is in the range of 1.5 μm to 10 μm, for example. Such micro-LEDs can be provided on wafers with non-destructively detachable holding structures for the micro-LED.

In principle, a micro-LED does not necessarily have to have a rectangular radiation emission surface. For example, a micro-LED can have a radiation emission area that is less than or equal to 100 μm or less than or equal to 70 μm in any lateral extension of the radiation emission area in top view of the micro-LED. For example, in the case of rectangular micro-LEDs, an edge length is less than or equal to 70 μm or less than or equal to 50 μm, particularly when viewed from above.

Micro-LEDs are currently primarily used in displays. The micro-LEDs form pixels or sub-pixels and emit light of a defined color. Due to the small pixel size and high density with a small distance, micro-LEDs are suitable for small monolithic displays for applications in the field of augmented reality, AR for short, in particular for data glasses. Work is also underway on other applications, in particular the application in data communication or pixelated lighting applications. Various spellings for micro-LED can be found in the literature, such as μLED, μ-LED, uLED, u-LED or Micro Light Emitting Diode.

In addition, a measurement method is provided by which a semiconductor light source as described in connection with one or more of the above embodiments is operated. Features of the semiconductor light source are therefore also disclosed for the measurement method and vice versa.

In at least one embodiment, the measurement method comprises the following steps, in particular in the order indicated and/or repetitive:
Detecting the at least one electric parameter for the lighting strips, and
using the at least one electric parameter for a fault analysis of the lighting strips.

### BRIEF DESCRIPTION OF THE DRAWINGS

In the following, a semiconductor light source described herein and a method described herein are explained in more detail with reference to the drawing by means of exemplary embodiments. Identical reference signs indicate identical elements in the individual figures. However, no references to scale are shown; rather, individual elements may be shown in exaggerated size for better understanding.

The figures show:

FIG. 1 shows a schematic circuit diagram of an exemplary embodiment of a semiconductor light source described herein,

FIGS. 2 to 4 show schematic top views of exemplary embodiments of semiconductor light sources described herein,

FIGS. 5 and 6 show schematic circuit diagrams of exemplary embodiments of semiconductor light sources described herein, and

FIG. 7 shows a schematic block diagram of an exemplary embodiment of a measurement method for semiconductor light sources described herein.

### DETAILED DESCRIPTION

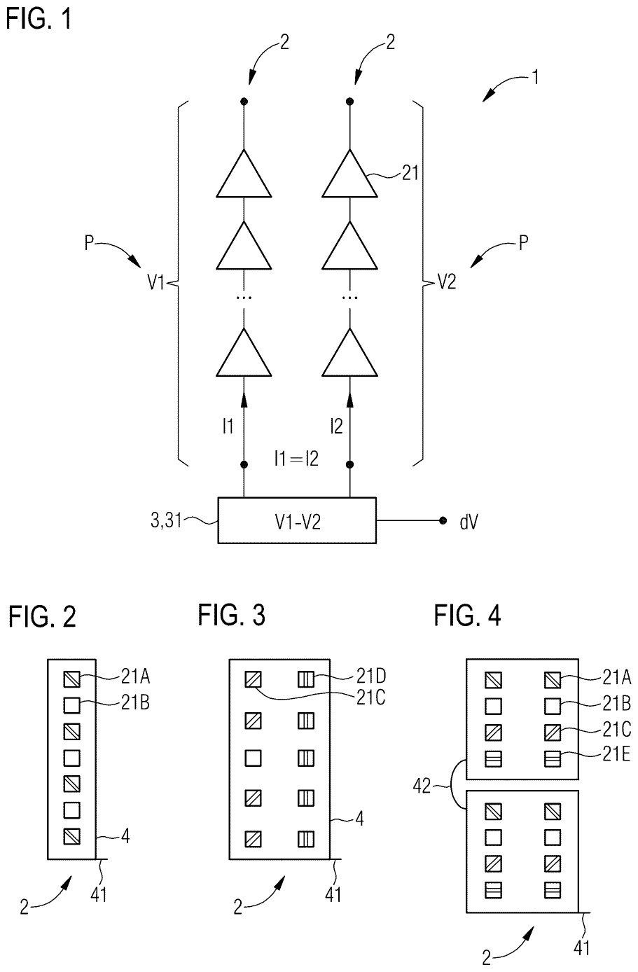

FIG. 1 schematically illustrates a semiconductor light source 1. The semiconductor light source 1 comprises a plurality of lighting strips 2. Each of the lighting strips 2 comprises a plurality of optoelectronic semiconductor chips 21, for example, LED chips or also LD chips, whereby phosphors may optionally be present. The optoelectronic semiconductor chips 21 within a lighting strip 2 can all be of the same design or different optoelectronic semiconductor chips 21 can be combined with each other, for example, LED chips with different emission colors. The lighting strips 2 can have the same or different structures.

Within the lighting strips 2, the optoelectronic semiconductor chips 21 are at least partially present in an electrical series connection. According to FIG. 1, the lighting strips 2 are constructed as pure series connections. In FIG. 1, only two lighting strips 2 are shown by way of example, but there can also be more than two lighting strips 2.

Furthermore, the semiconductor light source 1 comprises a control unit 3. A comparison module 31 is located in the control unit 3. All lighting strips 2 are connected to the control unit 3, for example, electrically in parallel with each other. This means that the control unit 3 can have a separate electrical output for each of the lighting strips 2.

The lighting strips 2 are operated in the same way. In particular, this means that the lighting strips 2 are close to each other. For example, a distance between the lighting strips 2 is at most 5 mm or at most 2 mm. This distance is, for example, a distance between the nearest optoelectronic semiconductor chips 21 of the two lighting strips 2. Due to the small distance between them, the same ambient conditions, such as temperature and humidity, are present in both lighting strips 2. The lighting strips 2 can also be operated with the same current I1=I2, so that the same electrical operating conditions can be present. In order to compensate for ageing of the lighting strips 2 relative to each other, it is possible for the lighting strips 2 to be operated with the same operating times, for example, synchronously with each other.

The comparison module 31 is configured to compare one or more electric parameters P of the lighting strips 2 with each other. For example, the parameter P is an electric forward voltage with numerical values V1, V2 at the lighting strips 2. Alternative or additional electric parameters P are, for example, reaction times for a voltage build-up or drop, current levels or capacitances. This is also possible in all other exemplary embodiments.

One or more threshold values can be stored in the comparison module 31. In the comparison module 31, the numerical values of the parameter P of the lighting strips 2 are then compared with each other, for example, one or more differences are formed from the determined numerical values, by way of example by subtracting the numerical values from each other. The resulting at least one difference is compared with the threshold values. The comparison can be used to decide whether or not there is a fault in one of the lighting strips 2.

In the example of FIG. 1, a voltage difference dV=V1−V2 or dV=|V1−V2| is compared with the at least one threshold value. If dV is outside a specified value range for dV, there is an error and the comparison module 31 can output an error message.

As in all other examples, it is also possible for original values to be subtracted from the numerical values of the parameter P as measured at a specific point in time. In other words, only a drift or a shift in the numerical values of the parameter P relative to an initial value is then taken into account and compared with the at least one threshold value.

In the example of FIG. 1, this means that the following can then apply for the difference dV: dV=(V1−V1₀)−(V2−V2₀) or dV=|(V1−V1₀)−(V2−V2₀)|, where V1₀ and V2₀ are the numerical values of the forward voltage at an operating time of 0 h, that is, the lighting strips 2 that have just been produced. Such a measurement at 0 h operating hours can eliminate variations in the parameter of the lighting strips 2 that are caused, for example, by binning. The numerical values V1, V2 can be measured repeatedly, for example, periodically, and then compared with the threshold values in each case in order to perform the error analysis.

Because the at least one parameter P is determined for lighting strips 2 that are operated in the same way, wherein the lighting strips 2 in particular have the same structure, means that effects due to otherwise different environmental influences or ageing can be reduced or eliminated and precise fault determination of the lighting strips 2 is possible.

For example, the voltage differences that occur in the event of a fault in one of the optoelectronic semiconductor chips 21 in one of the lighting strips 2 are in the order of 1 V or 100 mV, for example, with ten optoelectronic semiconductor chips 21 in a series connection. Voltage differences due to temperature changes are already in the mV range per optoelectronic semiconductor chip 21 and different operating durations can also lead to voltage differences of several tens of mV. The parameter adjustment of the lighting strips 2, which are operated in the same way and in close proximity to each other, can thus significantly increase the accuracy of the fault analysis.

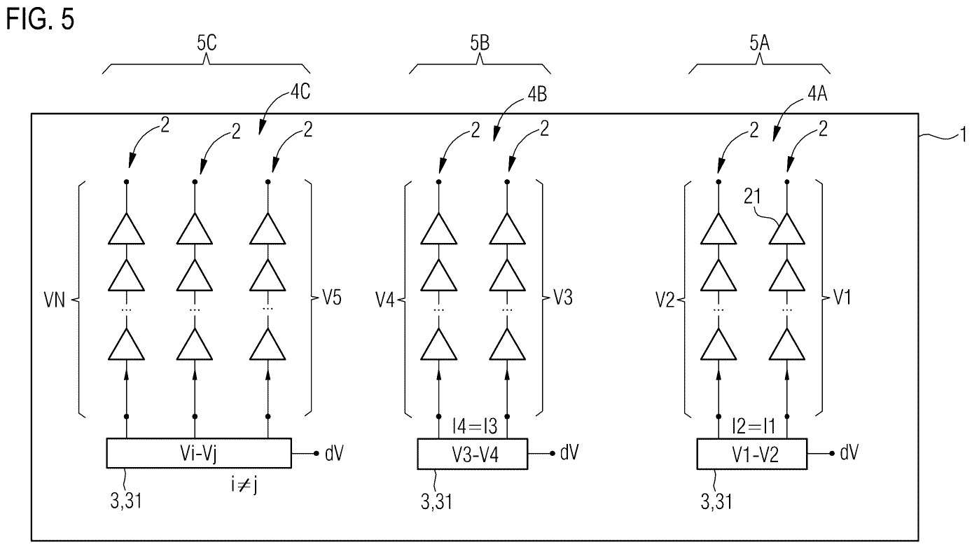

FIGS. 2 to 4 show several examples of the lighting strips 2. According to FIG. 2, a total of seven of the optoelectronic semiconductor chips 21 are present, for example in an alternating arrangement of first semiconductor chips 21A for emitting green light and second semiconductor chips 21B for emitting red light. All semiconductor chips 21A, 21B may be present in a linear arrangement on a common carrier 4.

Furthermore, as in all other examples, it is possible that the first semiconductor chips 21A are assigned to a first lighting strip 2 and the second semiconductor chips 21B are assigned to a second lighting strip and thus the semiconductor chips 21A, 21B of different lighting strips 2 are arranged in a linear, regularly alternating, linearly alternating or two-dimensionally intermixed arrangement, for example, on a common carrier 4. The semiconductor chips 21A, 21B, 21C, 21D, 21E illustrated in FIGS. 2 to 4 with different emission colors can thus also symbolize different lighting strips 2.

FIG. 3 shows that there are five third and five fourth semiconductor chips 21C, 21D, each arranged in a separate row. The semiconductor chips 21C on the one hand and the semiconductor chips 21D on the other hand can each be present in their own series circuit, whereby these two series circuits can be connected in parallel to each other. For example, the semiconductor chips 21C are configured to emit blue light and the semiconductor chips 21D are configured to emit violet or ultraviolet light, whereby in particular the semiconductor chips 21D can be assigned to phosphors that are not drawn.

According to FIG. 4, the lighting strip 2 is divided into several carriers 4, such as printed circuit boards. Each of the carriers 4 can comprise triples or quadruples of semiconductor chips 21, for example semiconductor chips 21A for green light, semiconductor chips 21B for red light and semiconductor chips 21C for blue light and optionally semiconductor chips 21E for white light. The carriers 4 can be connected to each other by means of an electrical connecting line 42. Furthermore, there may be an electrical connection 41 for connection to the control unit 3, not shown in FIG. 4.

The lighting strips 2 of FIGS. 1, 5 and 6 can, for example, be constructed as illustrated in connection with FIGS. 2 to 4, whereby mixtures of the designs of FIGS. 2 to 4 can also be realized.

In all other respects, the explanations relating to FIG. 1 apply in the same way to FIGS. 2 to 4, and vice versa.

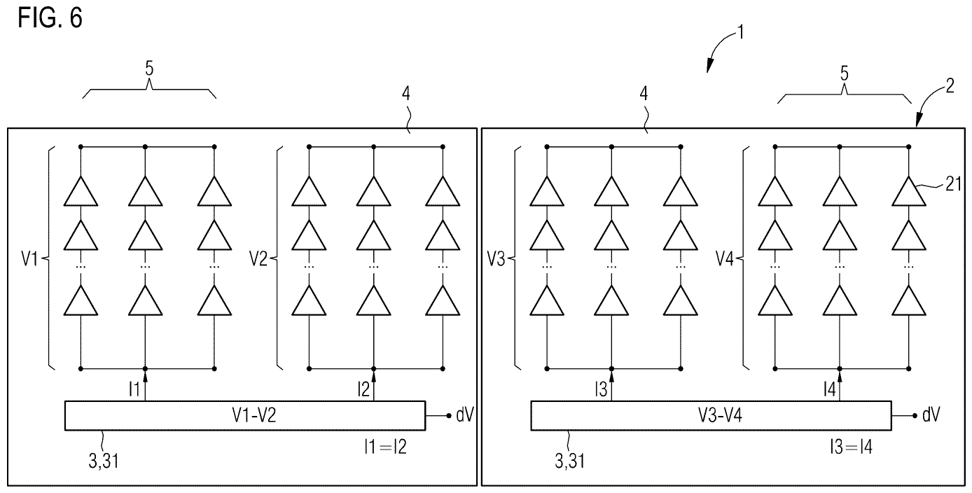

FIG. 5 shows that the semiconductor light source 1 has several groups 5A, 5B, 5C of lighting strips 2. Each group 5A, 5B, 5C has its own control unit 3. Each of the groups 5A, 5B, 5C has the same ambient conditions and/or the lighting strips 2 within each of the groups 5A, 5B, 5C are operated in the same way, for example with the same current, and/or the lighting strips 2 within each of the groups 5A, 5B, 5C have the same structure. This allows a precise fault analysis to be carried out for each of the groups.

Groups 5A, 5B are constructed as illustrated in connection with FIG. 1. In connection with group 5C, it is shown that there can also be more than two lighting strips 2, for example N−4 lighting strips 2, where N is a natural number greater than or equal to seven, so that group 5C has at least three of the lighting strips 2. The electric parameter P used for fault analysis is, for example, again the forward voltage, so that V5 . . . VN numerical values for the forward voltage to group 5C are recorded. For example, these numerical values are compared with each other in a rolling manner to determine the differences dV, so that a numerical value Vᵢ is compared with a numerical value Vⱼ with Vᵢ, Vⱼ∈ [5;

$${N ]}_{ℕ}$$

with i≠j. An error message is only issued, for example, if a minimum number of differences dV lies within an error range.

The differences dV from the voltages V1 . . . VN are determined directly by means of a subtractor circuit, for example. It is possible that within each of the groups 5A, 5B, 5C the measurement of the numerical values is carried out on exactly one ADC of the control unit 3. This means that the different lighting strips 2 within each of the groups 5A, 5B, 5C can be measured via multiplexing.

To control the lighting strips 2, it is possible to send only one control signal per group 5A 5B, 5C or per several of the lighting strips 2 to the control units 3. For example, the lighting strips 2 within group 5A or across groups 5A, 5B are all operated with the same control signal. This makes it possible to reduce the utilization of a data bus while still using a sufficiently high number of lighting strips 2 to be able to carry out a reliable fault analysis. In the case of similar lighting strips 2, a pair formation can thus be carried out during control in order to reduce the amount of bus data required.

Otherwise, the explanations relating to FIGS. 1 to 4 apply in the same way to FIG. 5, and vice versa.

FIG. 6 illustrates that combined series and parallel circuits can be present within the lighting strips 2. It is possible that the lighting strips 2 within a group 5 are in turn operated with the same current in order to perform a reliable fault analysis.

As is also possible in all other examples, differently configured lighting strips 2 can be combined with each other within one group 5. The at least one threshold value for the difference dV needs to be set accordingly. It is possible that the at least one threshold value can also be programmed during operation and not only at the factory, for example, only after the lighting strips 2 have been installed.

Otherwise, the explanations relating to FIGS. 1 to 5 apply in the same way to FIG. 6, and vice versa.

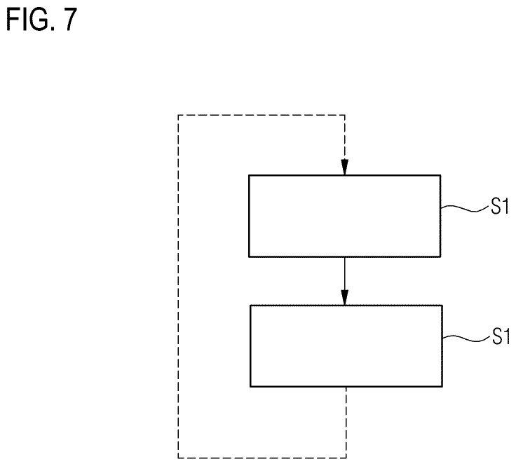

FIG. 7 shows a block diagram of the measurement method.

For example, the method steps shown are preceded by measuring the numerical values for the at least one electric parameter at the start of operation of the lighting strips 2 in order to obtain 0 h values. This can still be done at the factory. These 0 h values can, for example, serve as initial values for calculating a difference.

In step S1, the numerical values for the individual lighting strips are then measured and, for example, a difference is calculated. Step S1 can include subtracting the 0 h values from the currently determined difference in order to reduce or eliminate a variance due to, for example, binning tolerances. When measuring the numerical values, the lighting strips 2 are operated with the same current, for example; if no numerical values are currently being determined, it is also possible for the lighting strips 2 to be operated with different currents.

In step S2, the error analysis is then carried out, for example, using the difference between the forward voltages and/or a comparison with the at least one threshold value.

Steps S1, S2 can be repeated cyclically.

Otherwise, the explanations related to FIGS. 1 to 6 apply in the same way to FIG. 7, and vice versa.

The components shown in the figures preferably follow one another in the specified sequence, in particular directly after one another, unless otherwise described. Components not touching each other in the figures preferably have a distance between them. If lines are drawn parallel to each other, the associated surfaces are preferably also aligned parallel to each other. Furthermore, the relative positions of the drawn components to each other are correctly shown in the figures, unless otherwise indicated.

The invention described herein is not limited by the description based on the embodiments. Rather, the invention includes any new feature as well as any combination of features, which includes in particular any combination of features in the patent claims, even if this feature or combination itself is not explicitly stated in the patent claims or embodiments.

### LIST OF REFERENCE SIGNS

1 semiconductor light source
2 lighting strip
21 optoelectronic semiconductor chip
3 control unit
31 comparison module
32 memory unit
4 carrier
41 electrical connection
42 electrical connecting line
5 group
dV voltage difference
I overall current through a lighting strip
P electric parameter
S method step
V forward voltage

1. A semiconductor light source comprising:
a plurality of lighting strips, at least some of which are combined in a plurality of groups and at least one of the groups comprises at least three of the lighting strips, and
a control unit,
wherein:
each of the lighting strips comprises a plurality of optoelectronic semiconductor chips for generating light,
the lighting strips are operated in the same way within each of the groups, and
the control unit comprises a comparison module which is configured to detect at least one electric parameter of each of the lighting strips and to use numerical values for the individual lighting strips of the detected at least one electric parameter for a fault analysis,
the comparison module is configured to obtain a time course of the electric parameter,
the control unit is configured to perform a fault analysis for each of the groups individually, and
the control unit is configured to compare the numerical values of the lighting strips for the at least one group comprising the at least three of the lighting strips with one another in pairs and to output an error message if a minimum number of differences between the numerical values is within an error range.

2. The semiconductor light source according to claim 1,
wherein within each of the lighting strips at least some of the optoelectronic semiconductor chips are electrically connected in series.

3. The semiconductor light source according to claim 1,
wherein all the lighting strips are mounted on a common carrier and are arranged to be operated simultaneously.

4. The semiconductor light source according to claim 1,
wherein all the lighting strips are configured to be operated simultaneously in such a way that:
temperatures of the lighting strips differ by at most 5° C. from one another,
operating times of the lighting strips differ by at most a factor of 1.1 from one another, and
relative humidity of the lighting strips-differs by a maximum of five percentage points from one another.

5. The semiconductor light source according to claim 1,
wherein the comparison module is configured to determine differences from the numerical values for the lighting strips and to compare them with at least one threshold value which is stored in the comparison module.

6. The semiconductor light source according to claim 5,
wherein at least some of the lighting strips have the same structure, and the same at least one threshold value applies to these lighting strips.

7. The semiconductor light source according to claim 5,
wherein at least some of the lighting strips are constructed differently from one another, and different threshold values apply to these lighting strips.

8. The semiconductor light source according to claim 5,
wherein the comparison module comprises a memory unit which is configured to dynamically store the at least one threshold value.

9. The semiconductor light source according to claim 1,
wherein the electric parameter is a forward voltage and the lighting strips are configured to be operated with an equal non-zero total current intensity when detecting the electric parameter.

10. The semiconductor light source according to claim 1,
wherein the comparison module-comprises a measurement analog-to-digital converter,
wherein all numerical values are acquired with said measurement analog-to-digital converter.

11. The semiconductor light source according to claim 1,
wherein the comparison module is configured to detect the time course of the electric parameter with a detection frequency of at least once per hour and of at most 0.1 kHz.

12. The semiconductor light source according to claim 1,
wherein the lighting strips each comprise at least five and at most 100 of the optoelectronic semiconductor chips.

13. The semiconductor light source according to claim 1,
wherein a distance between adjacent ones of the lighting strips is at most 1 cm.

14. The semiconductor light source according to claim 1,
wherein all the groups comprise exactly two or exactly three of the lighting strips.

15. The semiconductor light source according to claim 1,
comprising at least ten of the lighting strips,
wherein several of the groups comprise at least three of the lighting strips.

16. (canceled)

17. A semiconductor light source comprising:
a plurality of lighting strips, at least some of which are combined in a plurality of groups and at least one of the groups comprises at least three of the lighting strips, and
a control unit,
wherein:
all the lighting strips are connected to the control unit and are connected electrically in parallel with each other,
each of the lighting strips comprises a plurality of optoelectronic semiconductor chips for generating light,
the lighting strips are operated in the same way within each of the groups, and
the control unit comprises a comparison module which is configured to detect at least one electric parameter of each of the lighting strips and to use numerical values for the individual lighting strips of the detected at least one electric parameter for a fault analysis,
the comparison module is configured to obtain a time course of the electric parameter with a detection frequency of at least once per hour and of at most 0.1 kHz,
the control unit is configured to perform a fault analysis for each of the groups individually, and
the control unit is configured to compare the numerical values of the lighting strips for the at least one group comprising the at least three of the lighting strips with one another in pairs and to output an error message if a minimum number of differences between the numerical values is within an error range.

18. A measuring method for a semiconductor light source according to claim 17, comprising the steps of:
detecting the at least one electric parameter for the lighting strips, and
using the at least one electric parameter for a fault analysis of the lighting strips.
